(19) United States
(12) Patent Application Publication
(10) Pub. No.: US 2012/0320579 A1
(43) Pub. Date: Dec. 20, 2012

(54) Diffuser Assembly for LED Lighting Fixture

(75) Inventors: Christopher J. Ferguson, Westchester, IL (US); Michael T. Thornton, Burr Ridge, IL (US); Edwin Vice, JR., Chicago, IL (US)

(73) Assignee: Focal Point, L.L.C., Chicago, IL (US)

(21) Appl. No.: 13/164,242

(22) Filed: Jun. 20, 2011

(51) Int. Cl. F21V 29/02; F21V 9/08; F21V 11/00

(52) U.S. Cl. 362/235; 362/355

(57) ABSTRACT

In an embodiment, a diffuser assembly for a multiple-LED lighting lamp is provided. The diffuser assembly is configured to be attached to multiple-LED lighting lamp with a center cavity and an integral fan that draws air from the lighting lamp to cool the LEDs. The diffuser assembly may comprise a diffuser plate and a diffuser bushing. The diffuser plate may be generally circular in shape and may include a diffuser portion and a circular hole located in the center of the diffuser portion. The diffuser bushing may be configured to be inserted through the circular hole and into the center cavity of the multiple-LED lighting lamp.

### FIELD OF THE INVENTION

The present invention relates to diffusers, more specifically to diffusers and diffuser attachment assemblies for use in lighting fixtures and more specifically multiple-LED lighting fixtures.

### DESCRIPTION OF RELATED ART

Light emitting diode (LED) lighting fixtures are known and are typically being utilized as a feasible option in lighting applications. LED lighting fixtures may include fixtures that include multiple LEDs. Some of these multiple-LED lighting fixtures are available in flood and spot versions, making these lamps ideal for track and open recessed fixtures in rooms, hallways, lobbies, and retail displays.

Generally, LED lighting fixtures provide ambient level light at reduced operating and energy costs as compared to other lighting fixtures known and used in the art. Additionally, some LED lighting fixtures, namely LED lighting lamps, and more specifically multiple-LED lighting lamps provide spot and flood ambient level light to illuminate hard to maintain applications. Using LED lighting lamps may provide many advantages, such as lower operating and energy costs. However, these LED lighting lamps, especially at higher power levels (such as 7 W and 10 W), may require a cooling system as the LED lamps may operate at temperatures which are either unsafe or do not allow for proper operation of the LEDs. For example, some LED lamps may include an integral fan or active cooling system that cools the LED lamps. The integral fan may draw air into the lamp through a center cavity and then remove hot air from inside the light assembly allowing the LEDs to maintain proper thermal temperatures.

Diffusors are generally desirable for multiple LED lighting fixtures because the multiple LEDs create multiple light beams. Diffusors homogenize the beams of multiple LEDs into one smooth beam. This homogenization is especially ideal when aiming a light beam at an angle and lighting a vertical surface such as a picture to eliminate uneven light patterns on the picture. When a LED lighting fixture includes an integral fan, the integral fan makes placing traditional diffusers, which are usually solid glass diffusors, in front of the LED lamps via a traditional lens holder unusable as it would interrupt the proper flow of air into and out of the lamp. One example LED lamp lighting system as described above may be the Philips Endura™ LED MR16 Spot and Flood LED Lamps, specifically the 7 W and 10 W models. In such a circumstance it is desirable to attach a diffuser to this LED lighting assembly that does not block the operation of the integral fan.

What is needed is a diffuser assembly that can be attached to the multiple-LED lighting lamp without interrupting the proper flow of air into and out of the lamp and that can provide some of the benefits provided by the above fixtures while providing a smooth beam.

### BRIEF SUMMARY OF THE INVENTION

In an embodiment of the present invention, a diffuser assembly is provided. The diffuser assembly may be utilized for the attachment to a multiple-LED lighting lamp with a center cavity and an integral fan that draws air from the lighting lamp to cool the LEDs. The diffuser assembly may comprise a diffuser plate and a diffuser bushing. The diffuser plate may be generally circular in shape and may include a diffuser portion and a circular hole located in the center of the diffuser portion. The diffuser bushing may include a first end and a second end opposite the first end. The first end may be configured to be inserted through the circular hole and into a center cavity of a multiple-LED lighting lamp. The second end may include an expanded portion. The diffuser bushing may further include a horizontal slot extending along the entire longitudinal axis of an exterior surface of the diffuser bushing. The diffuser bushing may further include at least one horizontal locking tab that extends along at least a portion of the longitudinal axis of the exterior surface of the diffuser bushing.

In another embodiment of the present invention, an LED lighting assembly is provided. The LED lighting assembly may include an LED lighting lamp, a diffuser plate, and a diffuser bushing. The LED lighting lamp may include multiple LEDs. The LED lighting lamp may also include an integral fan that cools the LEDs by extracting air into the LED lighting lamps and removing hot air from inside the LED lighting lamp to maintain proper thermal temperatures. The diffuser plate may be generally circular in shape and may include a diffuser portion and a circular hole located in the center of the diffuser portion. The diffuser bushing may include a first end and a second end opposite the first end. The first end may be configured to be inserted through the circular hole and into a center cavity of a multiple-LED lighting lamp. The second end may include an expanded portion. The diffuser bushing may further include a horizontal slot extending along the entire longitudinal axis of an exterior surface of the diffuser bushing. The diffuser bushing may further include at least one horizontal locking tab that extends along at least a portion of the longitudinal axis of the exterior surface of the diffuser bushing.

### BRIEF DESCRIPTION OF THE DRAWINGS

The present invention is illustrated by way of example and not limited in the accompanying figures in which like reference numerals indicate similar elements and in which:

FIG. 1 is an illustration of a side perspective view of a multiple-LED lamp in accordance with aspects of the invention;

FIG. 2 is an illustration of a front perspective view of the multiple-LED lamp depicted in FIG. 1 in accordance with aspects of the invention;

FIG. 3A is an illustration of a perspective view of an embodiment of a diffuser bushing in accordance with aspects of the invention;

FIG. 3B is an illustration of a perspective view of an embodiment of a diffuser plate in accordance with aspects of the invention;

FIG. 3C is an illustration of a perspective view of an unassembled diffuser assembly that includes the diffuser bushing depicted in FIG. 3A and the diffuser plate depicted in FIG. 3B in accordance with aspects of the invention;

FIG. 4 is an illustration of a side perspective view of an assembled diffuser assembly in accordance with aspects of the invention;

FIG. 5 is an illustration of a front perspective view of the assembled diffuser assembly depicted in FIG. 4 in accordance with aspects of the invention;

FIG. 6 is an illustration of a side perspective view of the diffuser assembly depicted in FIG. 4 and the multiple-LED lamp depicted in FIG. 1 in accordance with aspects of the invention; and

FIG. 7 is an illustration of a front perspective view of the diffuser assembly depicted in FIG. 4 attached to the multiple-LED lamp depicted in FIG. 1 in accordance with aspects of the invention.

The reader is advised that the attached drawings are not necessarily drawn to scale.

### DETAILED DESCRIPTION OF THE INVENTION

Generally, LED lighting fixtures provide ambient level light at reduced operating and energy costs. Additionally, some LED lighting fixtures, namely LED lamps, and more specifically multiple-lamp LED lighting lamps provide spot and flood ambient level light to illuminate hard to maintain applications. While using LED lamps provides many advantages, such as lower operating and energy costs, LED lamps at higher power levels (such as 7 W and 10 W) may require a cooling system. For example, some LED lamps include an integral fan or an active cooling system that cools the LED lamps. The integral fan may draw air into the lamp through a center cavity and then remove hot air from inside the light assembly allowing the LEDs to maintain proper thermal temperatures. This integral fan makes placing traditional diffusers, which are usually solid glass diffusors, in front of the lamp via a traditional lens holder unusable as it would interrupt the proper flow of air into and out of the lamp. In such a circumstance it is desirable to attach a diffuser to this LED lighting assembly that does not block the operation of the integral fan.

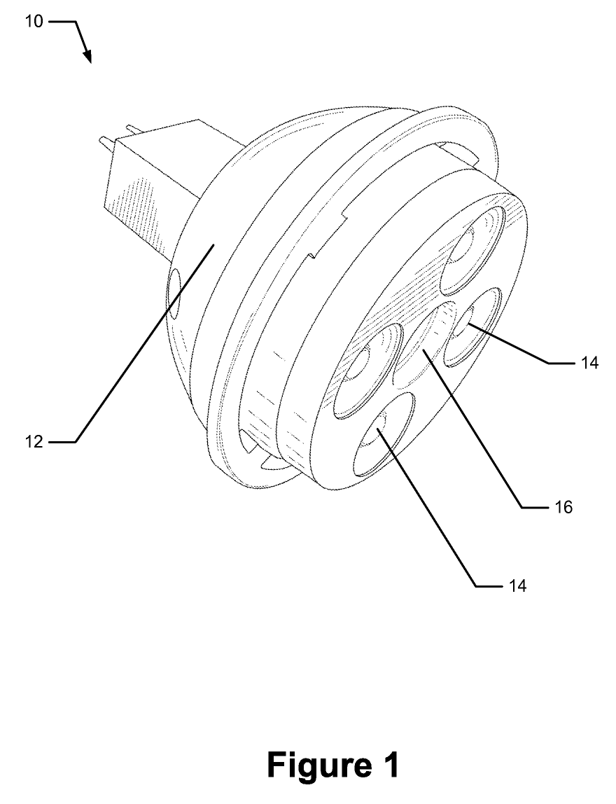

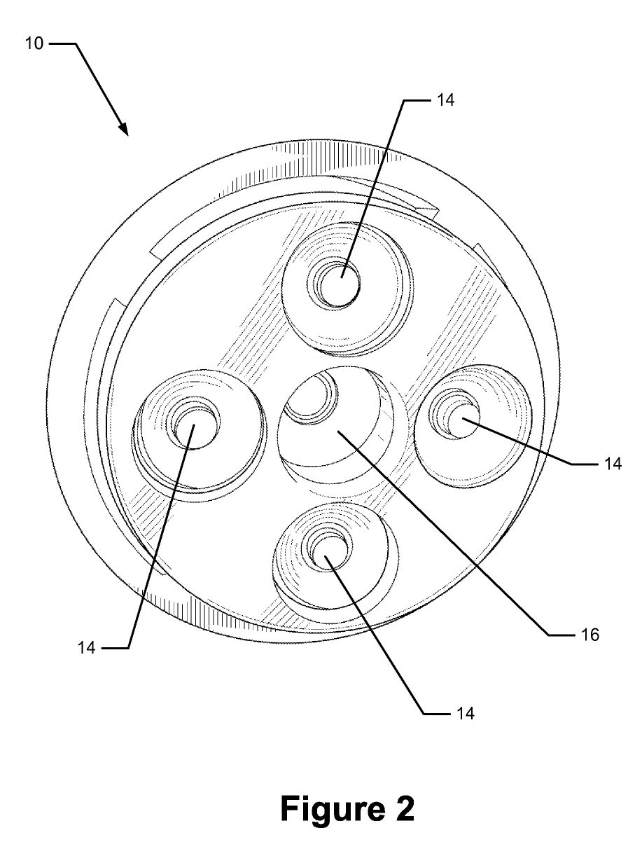

FIGS. 1 and 2 are illustrations of an exemplary multiple-LED lamp as described above. FIG. 1 is a front perspective view of the exemplary multiple-LED lamp, while FIG. 2 is a side perspective view of the exemplary multiple-LED lamp. As depicted, the multiple-LED lamp 10 includes a base 12 with multiple LEDs 14. As illustrated in FIGS. 1 and 2, the multiple-LED lamp 10 includes four LEDs 14. Any number of LEDs 14 may be utilized for a given light fixture 10 without departing from the present invention. The multiple-LED lamp 10 may also include a fan or active cooling assembly (not shown). The fan or active cooling assembly may be integral to the multiple-LED lamp. As illustrated in FIGS. 1 and 2, a central cavity 16 may be located on the multiple-LED lamp 10. As was described above, the integral fan or active cooling assembly may be utilized to cool the LED lamps 14 by drawing air into the lamp 10 through the central cavity 16, thereby removing hot air from inside the multiple-LED lamp 10 and allowing the LEDs 14 to maintain proper thermal temperatures.

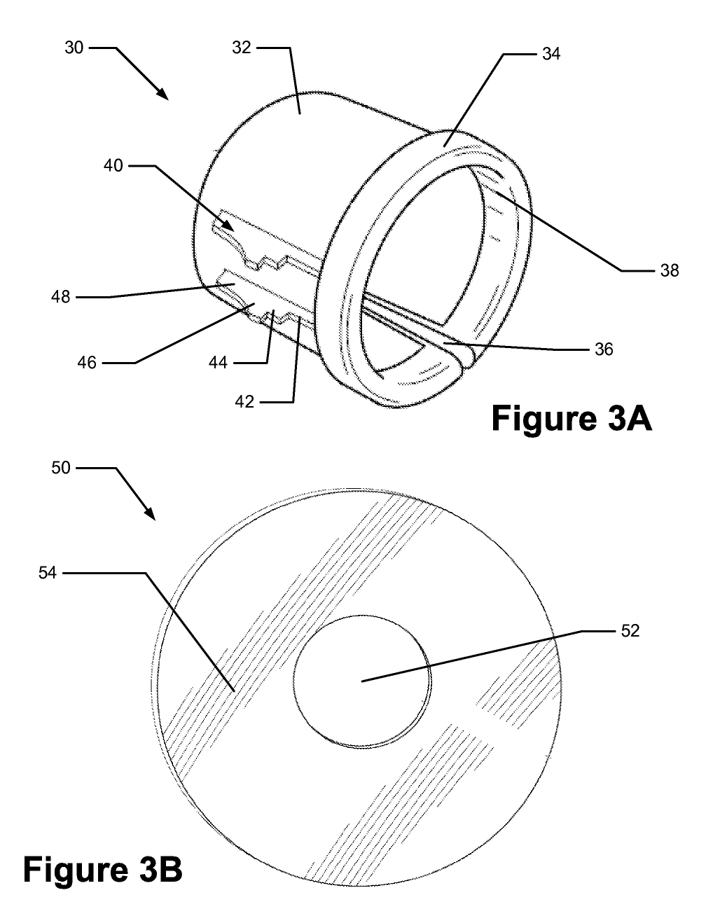

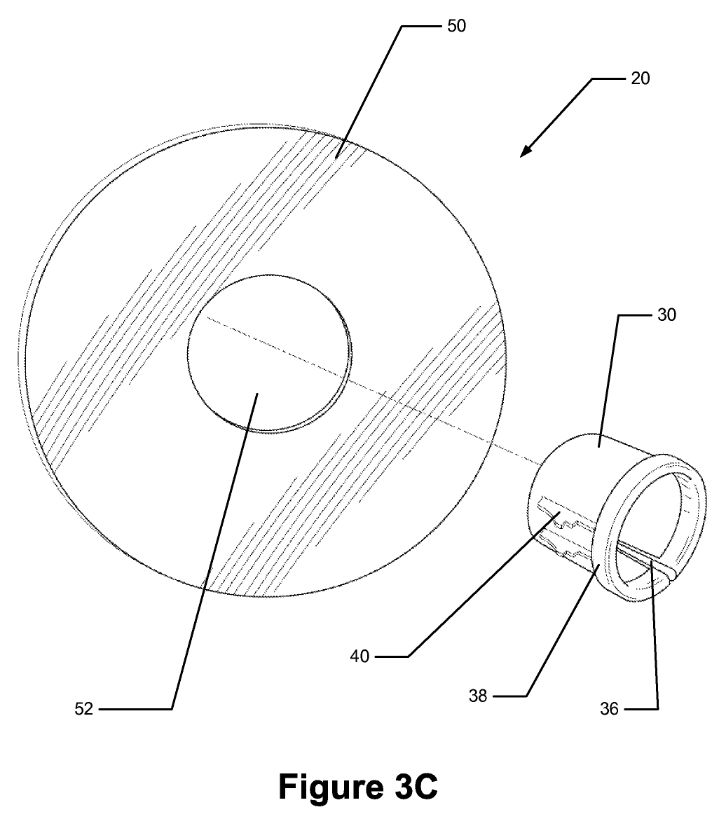

FIGS. 3A through 3C depict the components of an embodiment of a diffuser assembly 20. The diffuser assembly 20 may include both a diffuser bushing 30 (as illustrated in FIG. 3A) and a diffuser plate 50 (as illustrated in FIG. 3B). Additionally, as illustrated in FIG. 3C, the diffuser bushing 30 and the diffuser plate 50 may be operatively engaged to form the diffuser assembly 20.

FIG. 3A illustrates the diffuser bushing 30. The diffuser bushing 30 may generally be cylindrical in shape. The diffuser bushing 30 may include a first end 32 and a second end 34 opposite the first end 32. The first end may be configured to be inserted through the diffuser 50 and into the central cavity 16 of the multiple-LED lamp 10.

The diffuser bushing 30 may also include a horizontal slot 36. The horizontal slot 36 may extend along the longitudinal axis of an exterior surface of the diffuser bushing 30. The horizontal slot 36 may extend the entire longitudinal length of the diffuser bushing 30, as illustrated in FIG. 3A. The horizontal slot 36 allows the diffuser bushing 30 to contract to a smaller diameter while the diffuser bushing 30 is inserted into the central cavity 16 of the multiple-LED lamp 10. Once the diffuser bushing 30 has been inserted into the central cavity 16, the horizontal slot 36 allows the diffuser bushing 30 to expand, thereby helping to securely connect the bushing 30 to the lamp 10.

Additionally, the second end 34 may include an expanded portion 38. The expanded portion 38 may extend around the circumference of the second end 34. The expanded portion 38 may provide a stop that prevents the diffuser bushing 30 from extending completely through the diffuser plate 50. Additionally, the expanded portion 38 provides a strong base for securing the diffuser plate 50 to the diffuser bushing 30.

The diffuser bushing 30 may also include horizontal locking tabs 40. As illustrated in FIG. 3A, the diffuser bushing 30 includes two horizontal locking tabs 40. Any number of horizontal locking tabs 40 may be utilized for a diffuser bushing 30 without departing from the present invention. The horizontal locking tabs 40 may extend along the longitudinal axis of the exterior surface of the diffuser bushing 30.

As illustrated in FIG. 3A, the horizontal locking tabs 40 may include a first ridge 42, a second ridge 44, and a third ridge 46. The first ridge 42 may be located closest to the second end 34 of the bushing 30. The first ridge 42 may be sized and shaped to cooperatively engage with the diffuser plate 50 while securely maintaining and locking the diffuser plate 50 in place on the diffuser bushing 30. The second ridge 44 may be located next to the first ridge 42 and on the first end 32 side of the first ridge 44. The third ridge 46 may be located next to the second ridge 44 and on the first end 32 side of the second ridge 44. The second ridge 44 and the third ridge 46 may be sized and shaped to cooperatively engage with the central cavity 16 of the lamp 10, thereby locking the diffuser bushing 30 and the diffuser plate 50 to the lamp 10. The first ridge 42 may extend less than the second ridge 44 in a direction away from the exterior surface of the diffuser bushing 30. Additionally, the second ridge 44 may extend less than the third ridge 46 in a direction away from the exterior surface of the diffuser bushing 30. Other examples of locking configurations may be utilized for the horizontal locking tabs without departing from this invention. Additionally, the locking tabs 40 may include a tapered end 48 closest to the first end 32 of the bushing 30. The tapered end 48 may provide a smooth transition between the bushing 30 and the lamp 10, when inserting the bushing 30 into the central cavity 16 of the lamp 10.

The diffuser bushing 30 may be made from any desired materials without departing from this invention. In at least some example structures according to this invention, the diffuser bushing 30 will be made from a hard plastic, such as acrylonitrile butadiene styrene (ABS), nylon, polycarbonate, polymethyl methacrylate (PMMA), or a combination of the above mentioned materials. The various holes (e.g., horizontal slot 36) and/or surface structures (e.g., horizontal locking tabs 40) may be produced in the material in any desired manner without departing from the invention, including via production methods that are commonly known and used in the art, such as by drilling, tapping, machining, lathing, extruding, grinding, casting, extruding, molding, etc.

Additionally, the diffuser assembly 20 includes a diffuser plate 50 as illustrated in FIG. 3B. The diffuser plate 50 may be generally circular in shape. Additionally, the diffuser plate 50 may be other shapes without departing from the invention. The diffuser plate 50 may generally be in the shape of the multiple-LED lamp 10. As further illustrated in FIG. 3B, the diffuser plate 50 includes a hole 52 located in the approximate center of the diffuser plate 50. The hole 52 is sized and shaped to receive the first end 32 of the diffuser bushing 30. The diffuser plate 50 also includes a diffuser portion 54. The purpose of the diffuser portion 54 is to homogenize the beam of the multiple LEDs into one smooth beam. This may be ideal for when the multiple-LED lamp 10 is needed to aim a light beam at an angle and/or lighting a vertical surface such as a picture and eliminating uneven light patterns on this picture.

The diffusor portion 54 may also be a linear type diffuser which can spread the light from the multiple LEDs 14. Additionally, the diffuser portion 54 may include color filters which could be assembled with the other diffuser plates 50 on the diffuser bushing 30. In another example embodiment, the diffuser portion 54 of the diffuser plate 50 may include an integrated colored diffuser.

The diffuser plate 50 may be made from any desired materials without departing from this invention. In at least some example structures according to this invention, the diffuser plate 50 will be made from a hard plastic, such as acrylic, polycarbonate, polymethyl methacrylate (PMMA), or any combination of the above mentioned materials. The various holes (e.g., hole 52) may be produced in the material in any desired manner without departing from the invention, including via production methods that are commonly known and used in the art, such as by drilling, laser cutting, die cutting, tapping, machining, lathing, extruding, grinding, casting, extruding, molding, etc.

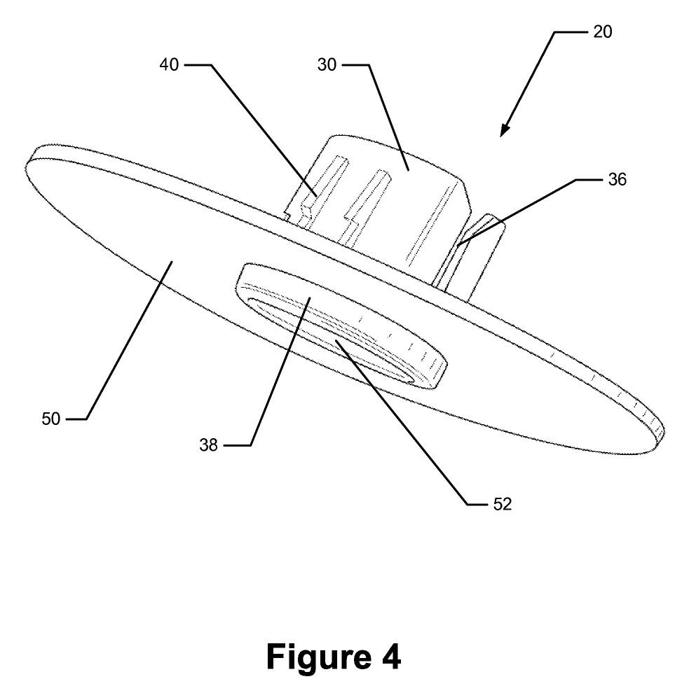

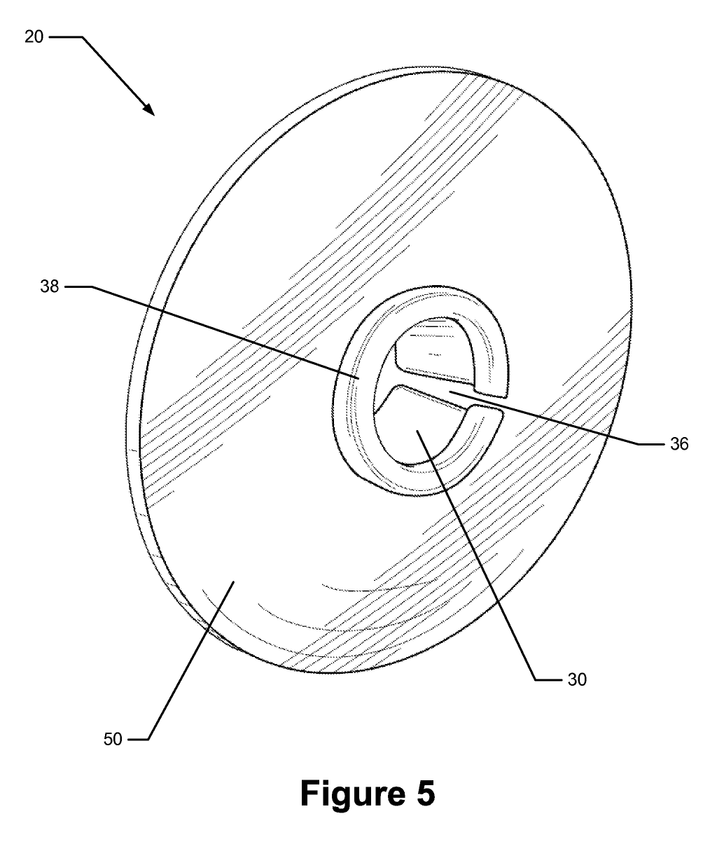

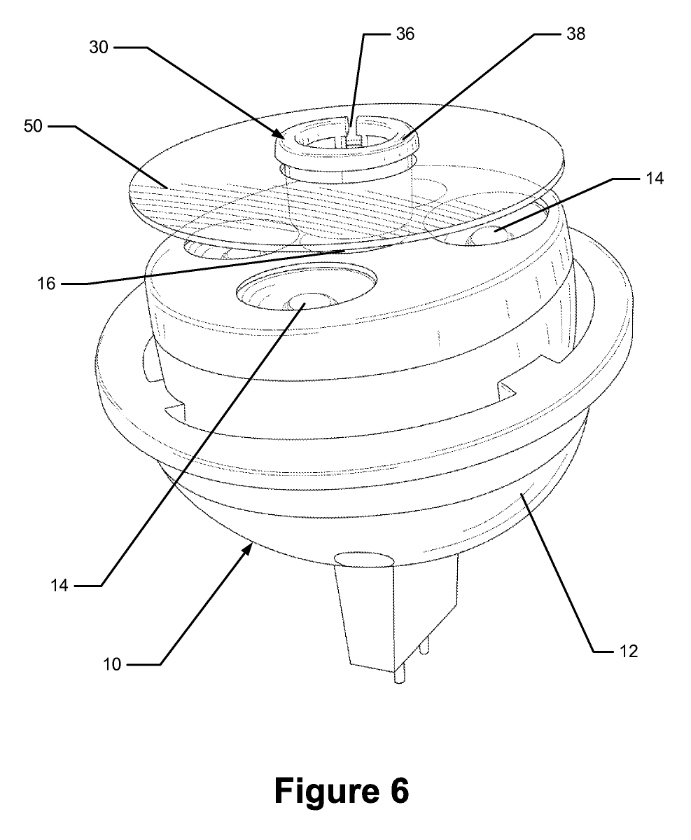

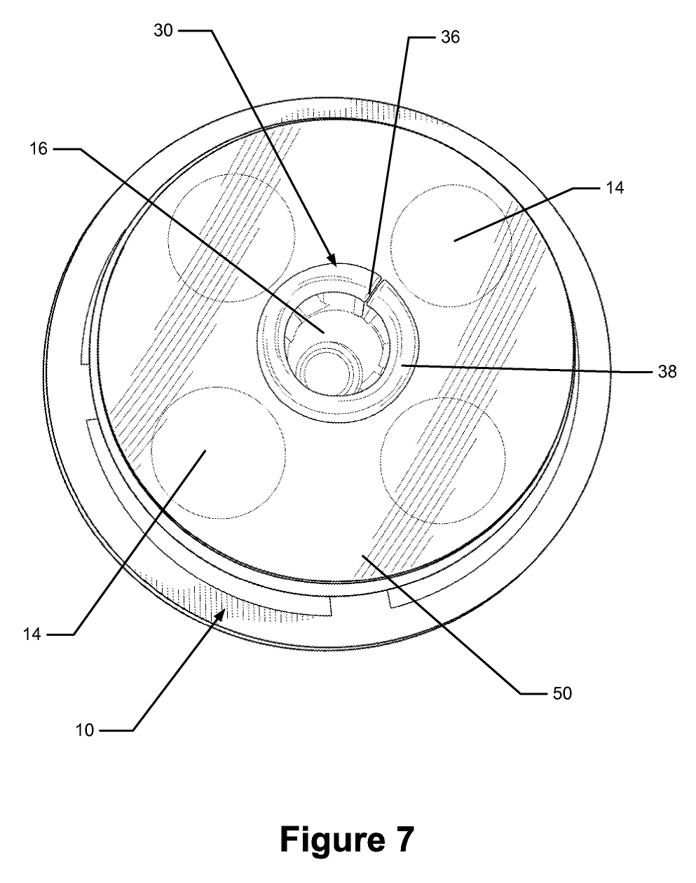

Attachment and assembly of the diffuser assembly 20 to the multiple-LED lamp 10 will be described in more detail as illustrated in FIGS. 3C through 7. FIG. 3C illustrates a perspective view of an unassembled diffuser assembly 20 that includes the diffuser bushing 30 depicted in FIG. 3A and the diffuser plate 50 depicted in FIG. 3B. FIG. 4 illustrates a side perspective view of the assembled diffuser assembly 20. FIG. 5 illustrates a front perspective view of the assembled diffuser assembly 20. FIG. 6 illustrates a side perspective view of the diffuser assembly 20 and the multiple-LED lamp 10. FIG. 7 illustrates a front perspective view of the diffuser assembly 20 attached to the multiple-LED lamp 10.

As illustrated in FIGS. 3C through 5, the diffuser bushing 30 is inserted into the diffuser plate 50. The first end 32 of the diffuser bushing 30 is inserted into the hole 52 of the diffuser plate 50. The first ridge 42 of the horizontal locking tabs 40 may engage the hole 52 and secure the diffuser plate 50 to the diffuser bushing 30. After the diffuser bushing 30 is secured to the diffuser plate 50, the diffuser assembly may then be attached to the multiple-LED lamp 10. As further illustrated in FIGS. 6 and 7, the first end of the diffuser bushing 30 may be inserted into the central cavity 16 of the multiple-LED lamp 10. As the first end of the bushing 30 is inserted into the central cavity 16, the second ridge 44 and/or third ridge 46 may engage the central cavity 16 of the multiple-LED lamp 10 and secure the diffuser assembly 20 to the lamp 10. As illustrated in FIGS. 6 and 7, when the diffuser assembly 20 is attached to the lamp 10, the integral fan or active cooling assembly is not covered. This allows the cooling of the LED lamps 14 by drawing air into the lamp 10 through the central cavity 16 and removing hot air from inside the multiple-LED lamp 10 and allowing the LEDs 14 to maintain proper thermal temperatures.

A potential advantage of a preferred embodiment of the present invention is to provide a diffuser assembly to a multiple LED lighting lamp that uses an integral fan. The diffuser assembly homogenizes the light beam of the multiple LEDs into one smooth beam, especially when aiming the light beam at an angle and lighting a vertical surface such as a picture. When the diffuser assembly is attached to the multiple LED lighting lamp, the diffuser assembly does not interrupt the proper flow of air into and out of the lamp thereby allowing the LEDs to maintain proper thermal temperatures.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A diffuser assembly for attachment to a multiple-LED lighting lamp with a center cavity and an integral fan that draws air from the lighting lamp to cool the LEDs, the diffuser assembly comprising:
a diffuser plate that is generally circular in shape and includes a diffuser portion and a circular hole located in the center of the diffuser portion; and
a diffuser bushing including a first end and a second end opposite the first end, wherein the first end is configured to be inserted through the circular hole and into a center cavity of a multiple-LED lighting lamp and the second end includes an expanded portion, the diffuser bushing further including a horizontal slot extending along the entire longitudinal axis of an exterior surface of the diffuser bushing, and the diffuser bushing further including at least one horizontal locking tab that extends along at least a portion of the longitudinal axis of the exterior surface of the diffuser bushing.

2. The diffuser assembly of claim 1, wherein the diffuser portion is a linear diffuser that is configured to evenly spread the light from a multiple-LED lighting lamp.

3. The diffuser assembly of claim 1, wherein the diffuser portion is a clear diffuser.

4. The diffuser assembly of claim 1, wherein the diffuser portion is a colored diffuser

5. The diffuser assembly of claim 1, wherein the at least one horizontal locking tabs includes a first ridge, a second ridge, and a third ridge.

6. The diffuser assembly of claim 5, wherein the first ridge is sized and shaped to cooperatively engage with the circular hole of the diffuser plate.

7. The diffuser assembly of claim 5, wherein the second ridge and the third ridge are sized and shaped to cooperatively engage with a central cavity of a multiple-LED lamp, thereby locking the diffuser bushing and the diffuser plate to the lamp.

8. The diffuser assembly of claim 1, wherein the at least one horizontal locking tabs includes a tapered end closest to the first end of the diffuser bushing that provides a smooth transition between the diffuser bushing and a multiple-LED lamp.

9. An LED lighting assembly, comprising:
an LED lighting lamp that includes multiple LEDs and an integral fan that cools the LEDs by drawing air into the LED lighting lamp and removing hot air from inside the LED lighting lamp to maintain proper thermal temperatures;
a diffuser plate that is generally circular in shape and includes a diffuser portion and a circular hole located in the center of the diffuser portion, wherein the diffuser plate is sized and shaped to correspond to the size and shape of the LED lighting lamp; and
a diffuser bushing including a first end and a second end opposite the first end, wherein the first end is inserted through the circular hole and into a center cavity of the LED lighting lamp and the second end includes an expanded portion, the diffuser bushing further including a horizontal slot extending along the entire longitudinal axis of an exterior surface of the diffuser bushing, and the diffuser bushing further including at least one horizontal locking tab that extends along at least a portion of the longitudinal axis of the exterior surface of the diffuser bushing.

10. The diffuser assembly of claim 9, wherein the diffuser portion is a linear diffuser that is configured to evenly spread the light from the LED lighting lamp.

11. The diffuser assembly of claim 9, wherein the diffuser portion is a clear diffuser.

12. The diffuser assembly of claim 9, wherein the diffuser portion is a colored diffuser

13. The diffuser assembly of claim 9, wherein the at least one horizontal locking tabs includes a first ridge, a second ridge, and a third ridge.

14. The diffuser assembly of claim 13, wherein the first ridge is sized and shaped to cooperatively engage with the circular hole of the diffuser plate.

15. The diffuser assembly of claim 13, wherein the second ridge and the third ridge are sized and shaped to cooperatively engage with the central cavity of the LED lighting lamp, thereby locking the diffuser bushing and the diffuser plate to the LED lighting lamp.

16. The diffuser assembly of claim 9, wherein the at least one horizontal locking tabs includes a tapered end closest to the first end of the diffuser bushing that provides a smooth transition between the diffuser bushing and the LED lighting lamp.

17. A diffuser assembly for attachment to a multiple-LED lighting lamp with a center cavity and an integral fan that draws air from the lighting lamp to cool the LEDs, comprising:
a diffuser plate that is generally circular in shape and includes a diffuser portion and a circular hole located in the center of the diffuser portion; and
a diffuser bushing including a first end and a second end opposite the first end, wherein the first end is configured to be inserted through the circular hole and into a center cavity of a multiple-LED lighting lamp and the second end includes an expanded portion, the diffuser bushing further including a horizontal slot extending along the entire longitudinal axis of an exterior surface of the diffuser bushing, and the diffuser bushing further including at least one horizontal locking tab that extends along at least a portion of the longitudinal axis of the exterior surface of the diffuser bushing, wherein the at least one horizontal locking tabs includes a first ridge, a second ridge, and a third ridge, with the first ridge sized and shaped to cooperatively engage with the circular hole of the diffuser plate and the second ridge and the third ridge are sized and shaped to cooperatively engage with a central cavity of a multiple-LED lamp, thereby locking the diffuser bushing and the diffuser plate to the lamp, and further wherein the at least one horizontal locking tabs includes a tapered end closest to the first end of the diffuser bushing that provides a smooth transition between the diffuser bushing and a multiple-LED lamp.

18. The diffuser assembly of claim 1, wherein the diffuser portion is a linear diffuser that is configured to evenly spread the light from a multiple-LED lighting lamp.

19. The diffuser assembly of claim 1, wherein the diffuser portion is a clear diffuser.
